(19) United States
(12) Patent Application Publication
(10) Pub. No.: US 2007/0086788 A1
(43) Pub. Date: Apr. 19, 2007

(54) Optical single sideband modulator

(75) Inventors: Paulo Monteiro, Ilhavo (PT); Tiago Silveira, Sangalhos (PT); Antonio Teixeira, Ilhavo (PT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/580,767

(22) Filed: Oct. 13, 2006

(30) Foreign Application Priority Data
Oct. 14, 2005 (EP) 05022460.9

(51) Int. Cl. H04B 10/04

(52) U.S. Cl. 398/186

(57) ABSTRACT

The optical single sideband modulator includes an amplitude modulator and a converter comprising a semiconductor optical amplifier, using the chirp effect to convert an amplitude modulated optical signal into a single sideband signal without a filter for eliminating one of the sidebands.

### CROSS REFERENCE TO RELATED APPLICATIONS

This application claims priority of European application No. 05022460.9 EP filed Oct. 14, 2005, which is incorporated by reference herein in its entirety.

### FIELD OF INVENTION

The invention relates to an optical single sideband modulator.

### BACKGROUND OF THE INVENTION

Optical single sideband modulation OSSB has three important advantages in optical communications compared with double sideband modulation:

OSSB systems most obvious advantage is the reduction of spectral occupancy and therefore the increased number of transmission channels in a wavelength multiplex signal compared with conventional systems,

OSSB systems have higher tolerance to chromatic dispersion introduced by the optical transmission fiber,

OSSB systems allow electrical compensation and electrical precompensation.

The most common generation of OSSB signals is performed by an optical modulator generating a double sideband signal. The double sideband modulated signal is fed to an optical filter to suppress one sideband.

This arrangement is expensive and is unable to obtain a good suppression of one sideband without attenuating the optical carrier. Further it has the disadvantage that information can be lost if the filter or laser is detuned.

### SUMMARY OF THE INVENTION

It is an object of the invention to provide a low cost optical single sideband modulator without wavelength stability problems.

According to the present invention the optical single sideband modulator includes an amplitude modulator and a semiconductor optical amplifier [SOA], using a chirp effect to convert an amplitude modulated optical signal into a single sideband signal without the help of a filter for eliminating one of the sidebands.

The optical single sideband generator can be easily adapted to different bit rates by controlling the power of a modulated optical signal, which is fed to the SOA, or the operating voltage.

The main advantage of the invention is that the carrier is not suppressed and no information loss according to detuning of a sideband suppression filter results in a loss of information.

### DESCRIPTION OF THE DRAWINGS

FIG. 1 shows the first preferred embodiment of the optical single sideband modulator,

FIG. 2 shows a second preferred embodiment of a converter,

FIG. 3 shows a modulated double sideband and a single sideband signal,

FIG. 4 shows the eye opening for double and single sideband modulation,

FIG. 5 shows a system with a separate double sideband/single sideband converter.

### DETAILED DESCRIPTION OF INVENTION

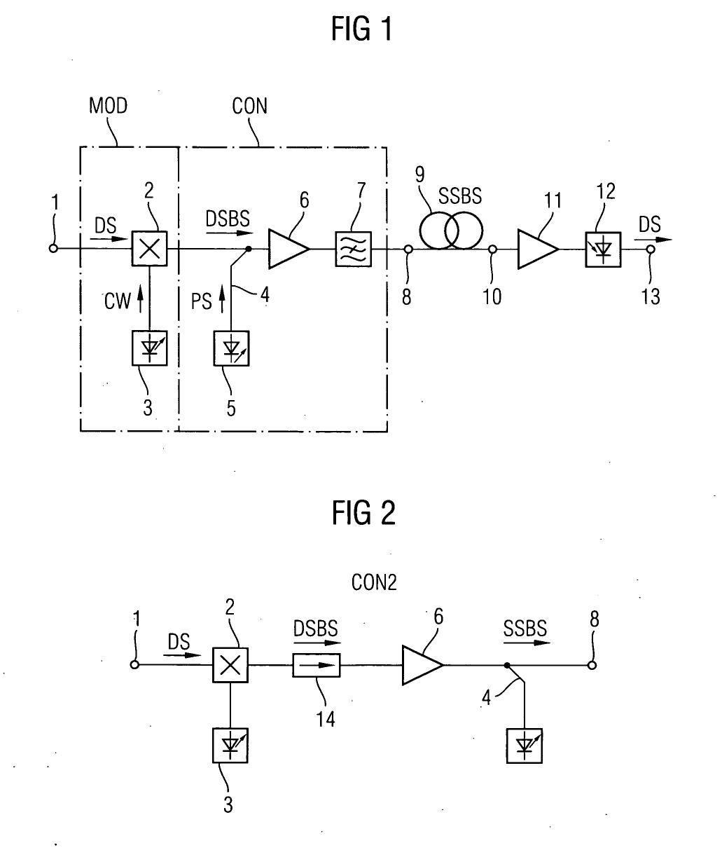

FIG. 1 shows a single sideband modulator comprising an optical am modulator MOD/2,3 (amplitude modulation), e.g. Mach-Zehnder modulator, and an ODSB-OSSB converter CON/4,5,6 (optical double sideband—optical single sideband) connected in series.

A binary data signal DS is fed to a signal input 1 of the modulator device 2, which receives a CW (constant wavelength) signal from a laser 3 and outputs an optical amplitude modulated double sideband signal DSBS. This signal is combined with a pump signal PS generated by a pump source 5 in a coupler or a filter (wavelength multiplexer) 4 and passed to a signal input of a semiconductor optical amplifier (SOA) 6, which performs the ODSB-OSSB conversion. The pump signal PS is used to maintain the SOA in the saturated region.

The transfer function of the SOA can be described approximately by:

$${E}_{out} ( t ) = {E}_{in} ( t ) e \frac{( 1 + jα ) \cdot Γ \cdot g ( {E}_{in} ( t ) ) \cdot L - {α}_{s} \cdot L}{2} \qquad ( 1 )$$

Where Eᵢₙ is the optical field at the input, Eₒᵤₜ is the optical field at the output, α is a parameter known as the linewidth enhancement factor, g is gain of the SOA, which is dependent on the input optical field, L is the length of the SOA, Γ is the optical confinement factor and α_{S} describes the losses in the waveguide.

[According to Agrawal, G. P. Olsen; N. A. “Self-phase modulation and Spectral Broadening of Optical Pulses in Semiconductor Laser Amplifiers”; IEEE Journal of Quantum Electronics, Vol. 25, No. 11, November 1989]

According to the formula (1) a phase modulation occurs inside the SOA driven by the input signal. A positive chirp is caused by a “1” to “0” (on→off) transition and a negative chirp is the result of a “0” to “1” (off→on) transition. The negative chirp transfers some power from the upper sideband to the lower sideband and the positive chirp will transfer some power from the lower the upper sideband. Since the power of 1's is higher than the power of 0's and the negative chirp is higher than the positive chirp the power transition to the lower sideband is higher than the power transition to the higher sideband (due to the fact that gain depletion inn a SOA is faster than gain recovery). The result is an optical single sideband signal SSBS.

The pump signal PS is used to maintain the SOA in the saturation region, otherwise there would be an overshoot in the transitions, especially during 0 to 1 transitions. A band stop filter 7 connected with the output of SOA eliminates the Pump signal.

The signal SSBS is transmitted—usually after additional amplification; not shown)—from the converter output 8 over a fiber 10 to a receiver 11, 12. Of course, a plurality of OSSB signals can be combined to a (dense) wavelength division multiplex signal.

The received signal OSSB is fed to a signal input 10 of an amplifier 11 and an outputted amplified signal is then converted into the electrical data signal DS by an optical-electrical converter working as a demodulator 12. Of course, chromatic dispersion compensation and polarisation mode dispersion compensation can be used for further improving the signal quality of the received signal.

FIG. 2 shows another preferred embodiment with a second converter CON2 of the single sideband modulator according to the invention. The SOA is pumped backwards over the coupler 4 by the pump source 5. A pump rejection filter is not necessary. An isolator (or an optical filter) 14, inserted before the signal input of the SOA, keeps the pump signal PS away from the modulator device 2.

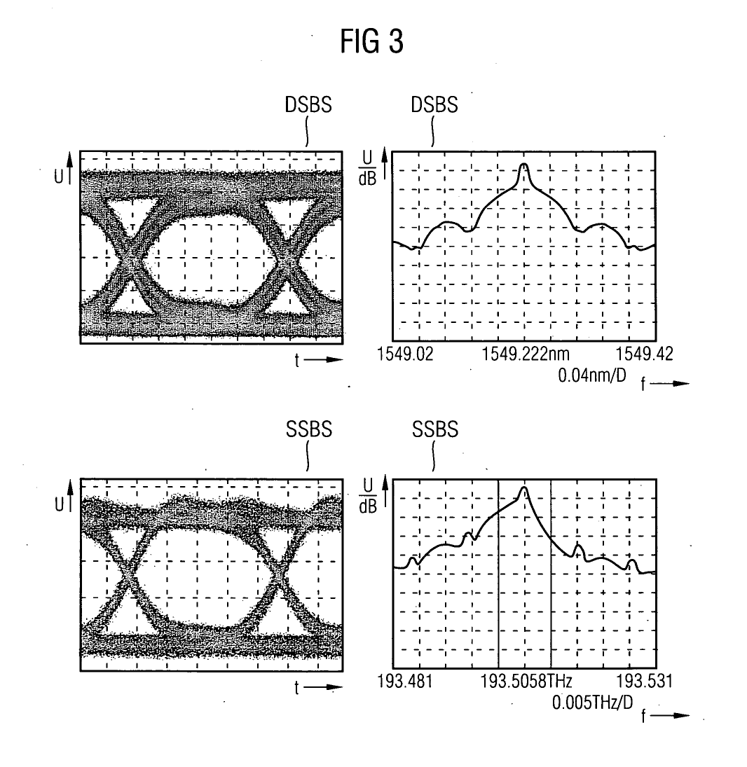

FIG. 3 illustrates the difference between a double sideband signal DSBS at the SOA input (top) and the single sideband signal SSBS at the SOA/converter output (below) in the time domain [t] an in the frequency domain [f]. On the left side the vertical axis shows an appropriate output voltage of a demodulator and on the right side the vertical axis shows the output voltage U of a spectral analyser in dB. It can be seen that the upper sideband is highly reduced.

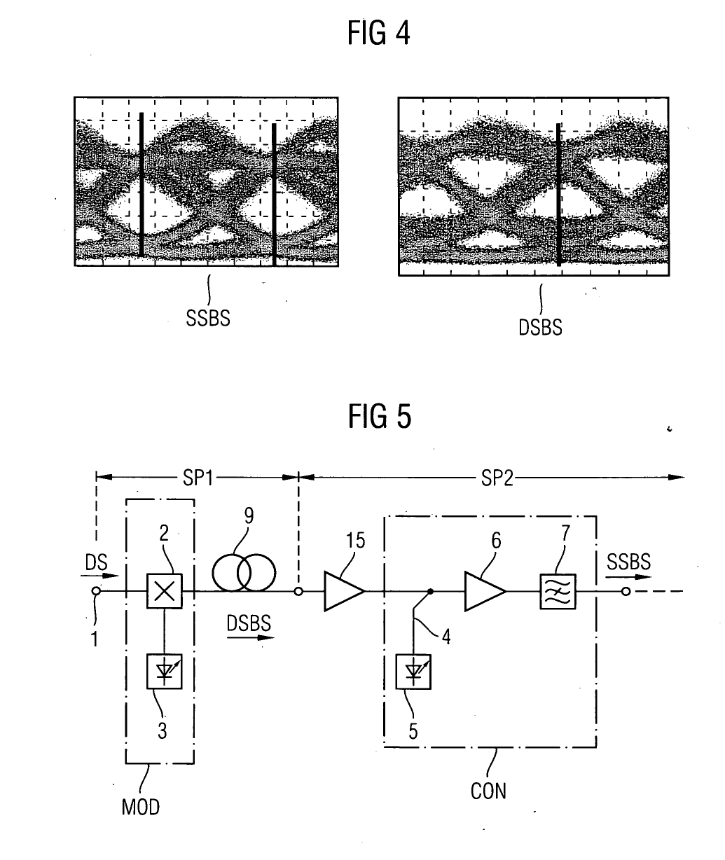

The improvement of single sideband modulation according to our invention becomes obvious from FIG. 4. On the left side the eye opening is shown for DSB signal DSBS and on the right side for our SSB signal SSBS after 80 km of fiber. Even after 160 km a high quality signal can be attained when SSB modulation according to the invention is used.

FIG. 5 shows a composite transmission line. A normal ODSB signal is transmitted over a first span SP1 with e.g. 40 km. At end of this span (the beginning of the next span) the received signal is amplified by an EDFA span amplifier 15 and transformed the ODSB-OSSB converter CON into an OSSB signal, which is transmitted over a second span SP2. This solution is advantageous, when OSSB signals are received from third party lines. Beside the conversion into an OSSB signal a 2R regeneration is performed by the ODSB-OSSB converter: the received signals are amplified and the “1” impulses are shortened.

1.-4. (canceled)

5. A single sideband modulator, comprising:
an optical amplitude modulator;
an optical double sideband—optical single sideband converter comprising a semiconductor optical amplifier, the optical double sideband—optical single sideband converter connected in series to the optical amplitude modulator;
an optical amplitude modulated double sideband signal generated from an optical carrier signal fed to the optical amplitude modulator and a binary data signal fed to an modulation input of the optical amplitude modulator; and
a single sideband modulated signal generated from the generated double sideband signal fed to a signal input of the amplifier and an optical pump signal fed to the amplifier to keep the amplifier in a saturated region.

6. The single sideband modulator according to claim 5,
further comprises a coupler or a filter inserted between the optical amplitude modulator and the amplifier,
wherein the pump signal is fed to a second input of the coupler or filter, where the signal is combined with the optical double sideband signal and applied to the signal input of the amplifier.

7. The single sideband modulator according to claim 5,
further comprises a coupler or a filter connected to the output of the amplifier,
wherein that the pump signal is inputted at a second connection point of the coupler or filter and fed backwards to the amplifier.

8. The single sideband modulator according to claim 5, wherein the amplitude modulator is positioned at the beginning of a transmission span and the converter is positioned at the end of that span.
